(19) United States
(12) Patent Application Publication
(10) Pub. No.: US 2016/0068143 A1
(43) Pub. Date: Mar. 10, 2016

(54) Adaptive Driver Assist

(71) Applicant: Continental Automotive Systems, Inc., Auburn Hills, MI (US)

(72) Inventors: Holger Schanz, Lake Orion, MI (US); Joseph Burtch, Lake Orion, MI (US); Riley S. McGarry, Oxford, MI (US); Gentian Godo, Troy, MI (US); Thomas Koelzer, Emmelshausen (DE); Zachary Joseph Bolton, Birmingham, MI (US); Jeremy J. McClain, Oxford, MI (US)

(21) Appl. No.: 14/666,264

(22) Filed: Mar. 23, 2015

Related U.S. Application Data
(63) Continuation-in-part of application No. 14/147,648, filed on Jan. 6, 2014.
(60) Provisional application No. 61/748,889, filed on Jan. 4, 2013.

(51) Int. Cl. B60T 7/22; B60Q 9/00; B60R 1/00

(52) U.S. Cl. CPC B60T 7/22; B60R 1/00; B60Q 9/008; B60R 2300/802

(57) ABSTRACT

A safe driving system for alerting a driver within a vehicle is provided. The system includes a driver assistance device configured to perform at least one of the following: automatically braking the vehicle if the vehicle is within a predetermined distance of a second vehicle and providing blind spot assistance. The system also includes a controller configured to track a driver's face with an interior camera resulting in tracked driver's face data. The controller is configured to determine whether the driver is distracted based on the tracked driver's face data. The controller is configured to activate the driver assistance device if the driver is distracted and the hazard detecting device detects at least one of the second vehicle or a third vehicle in the blind spot of the driver. A method for assisting a driver of a vehicle and a non-transitory machine-readable medium that provides instructions are also provided.

### CROSS-REFERENCE TO RELATED APPLICATIONS

This application is a continuation-in-part of U.S. application Se. No. 14/147,648, filed on Jan. 6, 2014, which claims the benefit of U.S. Provisional Application No. 61/748,889, filed on Jan. 4, 2013, both of which are incorporated by reference herein in their entireties.

### TECHNICAL FIELD

The present disclosure relates to automotive vehicles, and more particularly to systems, methods, and devices for assisting a driver in an automotive vehicle.

### BACKGROUND

Advancements in available sensor technologies allow for improved safety systems for vehicles. One such improved system is an arrangement and method for detecting and avoiding collisions. This type of system is referred to as a driver assistance system. Driver assistance systems can include sensors located on the vehicle to detect an oncoming collision. The systems may warn the driver of various driving situations to prevent or minimize collisions using any number of available warning systems. Furthermore, driver assistance systems can provide specialized warnings for any number of conditions that could potentially lead to a collision. For example, alerts may be provided for lane departure warnings, forward collision, warnings, blind spot detection, etc.

Existing warning systems typically provide either an audible warning, a dashboard/windshield mounted visual cue, or a combination of the two. The dashboard/windshield mounted visual cues assume that the driver is attentive and forward facing. In cases where the driver is not attentive, or is looking elsewhere, the dashboard/windshield mounted visual cues are ineffective.

### SUMMARY

Disclosed are a driver assistance apparatus, system, and method that are configured to automatically control a vehicle when the driver is distracted or otherwise looking away.

In one form, which may be combined with or separate from other forms described herein, there is contemplated a safe driving system for alerting a driver within a first automotive vehicle. The safe driving system includes a driver assistance device configured to assist a driver with operation of the first vehicle by performing at least one of the following: automatically braking the first vehicle if the first vehicle is within a predetermined distance of a second vehicle and providing blind spot assistance if a third vehicle is in a blind spot of the driver. A controller is configured to track a driver's face with an interior camera resulting in tracked driver's face data. The controller is further configured to determine whether the driver is distracted based on the tracked driver's face data. A hazard detecting device is communicatively coupled to the controller. The hazard detecting device is configured to detect the second vehicle and the third vehicle. The controller is configured to activate the driver assistance device if the driver is distracted and the hazard detecting device detects at least one of the second vehicle and the third vehicle.

In another form, which may be combined or separate from the first form, a method for assisting a driver of a first vehicle is provided. The method includes a step of tracking a driver's face with an interior camera resulting in tracked driver's face data and a step of determining whether the driver is distracted based on the tracked driver's face data. If the driver is distracted and the first vehicle is within a first predetermined distance from a second vehicle, the method includes regulating speed to a second predetermined distance from the second vehicle. Further, if the driver is distracted and a third vehicle is in a blind spot of the driver, and further if the first vehicle moves toward the third vehicle, the method includes producing at least one of an alert or a correction.

In yet another form, which may be combined with or separate from the other forms described herein, disclosed is a non-transitory machine-readable medium that provides instructions, which when executed by a machine, cause the machine to perform operations. The operations include tracking a driver's face with an interior camera resulting in tracked driver's face data; determining whether the driver is distracted based on the tracked driver's face data; if the driver is distracted and the first vehicle is within a first predetermined distance from a second vehicle, regulating speed to a second predetermined distance from the second vehicle; and if the driver is distracted and a third vehicle is in a blind spot of the driver, and further if the first vehicle moves toward the third vehicle, producing at least one of an alert or a correction.

### BRIEF DESCRIPTION OF THE DRAWINGS

The present disclosure will become more fully understood from the detailed description and the accompanying drawings, wherein:

FIG. 1 is a schematic illustration of a side view of a vehicle including a safe driving system, according to the principles of the present disclosure;

FIG. 2 is a schematic illustration of a top view of the vehicle of FIG. 1, shown in an environment with additional vehicles and a distraction, in accordance with the principles of the present disclosure; and

FIG. 3 is a schematic block diagram illustrating a method for assisting a driver of a vehicle, in accordance with the principles of the present disclosure.

### DETAILED DESCRIPTION

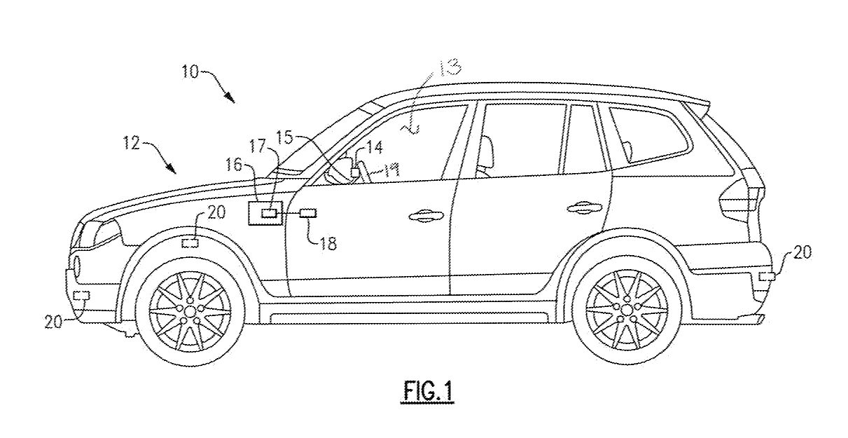

FIG. 1 illustrates a vehicle 10 including a safe driving system 12. As is explained in further detail below the safe driving system 12 incorporates driver focus recognition based on data from a driver analyzer to better assist the driver. The safe driving system 12 includes a driver analyzer 14 mounted to a steering column 15 in an interior space 13 of the vehicle 10. The driver analyzer 14 records a driver's head and transmits the head, eye, pupil, eyelid, and/or other facial feature position or information to a vehicle controller 16. The driver analyzer 14 can be a monocular camera, binocular camera, an array of cameras, or another type of sensing device capable of providing information functional to determine the direction of a driver's gaze. Throughout the disclosure, the relative directions of forward and rear are in reference to the direction that an operator for the vehicle 10 would primarily be facing when operating the vehicle 10. In the illustrated example, the driver analyzer 14 is a camera. The controller 16 includes a memory component 17.

The driver analyzer 14 can be mounted in any location that provides a view of the driver's head and/or face position. In some examples, a position in front of the driver is preferred. In the illustrated example, the driver analyzer 14 is mounted on the steering column 15 of the vehicle 10. However, other mounting locations for the driver analyzer 14 may also be considered depending on the structure of the vehicle 10. In an alternate example, the mounting location is at the top and center of the vehicle 10 passenger compartment, proximate to the traditional mounting location for a rear view mirror. In the alternate example, the driver analyzer 14 is mounted in a position that minimizes obstruction of the front windshield. The driver analyzer 14 can be connected to, and used by, other vehicle systems, in particular, other systems which utilize a driver's head position can be connected to the driver analyzer 14.

The controller 16 is communicatively coupled to the driver analyzer 14, and analyzes the image/data from the driver analyzer 14 to determine the direction of the driver's focus. For example, the controller 16 may analyze an image recorded by a camera position of the driver analyzer 14 and determine the position of the driver's eyes, nose, and mouth. Based on the position of the driver's eyes, nose and mouth, the controller 16 can determine the direction of the driver's focus. In some examples, the data from the driver analyzer 14 can also be utilized to recognize the driver via facial recognition and adjust driver specific settings.

In some examples, the controller 16 can also analyze additional information recorded by the driver analyzer 14 to determine the driver's level of attentiveness toward a driving task. In these examples, the controller 16 can use information such as blink rate, eyes open/closed, head movement, etc. to make this determination. In alternate examples, the direction of focus can be used to determine attentiveness.

The controller 16 is also connected to at least one driver assistance device or system 18. The driver assistance device or system 18 may be in communication with one or more hazard detecting devices, such as sensors 20, by way of example. In one example, the driver assistance device or system 18 may also include an emergency brake assistance system (referred to as a brake assist system) and the sensors 20 include long range radar sensors. The brake assist system can alternatively be referred to as “autonomous emergency braking” or “crash imminent braking.” Alternately or additionally, the device assistance device or system 18 can be any other type of driver assistance system, or may include multiple systems. For example, the driver assistance device or system may provide blind spot assistance, such as by providing an alert and/or automatic steering.

The controller 16 may track the driver's face with the camera of the driver analyzer 14, resulting in tracked driver's face data. The controller 16 may then determine whether the driver is distracted, such as by determining the direction of a driver's focus and/or level of the drivers attention level based on the data from the driver analyzer 14.

The response provided by the controller 16 (or other additional controller or system 18) may be adapted based on the driver's focus and/or attentiveness. By way of example, the controller 16 can cause the driver assistance device or system 18 to provide a warning, automatic braking, an automatic steering function, or any similar response.

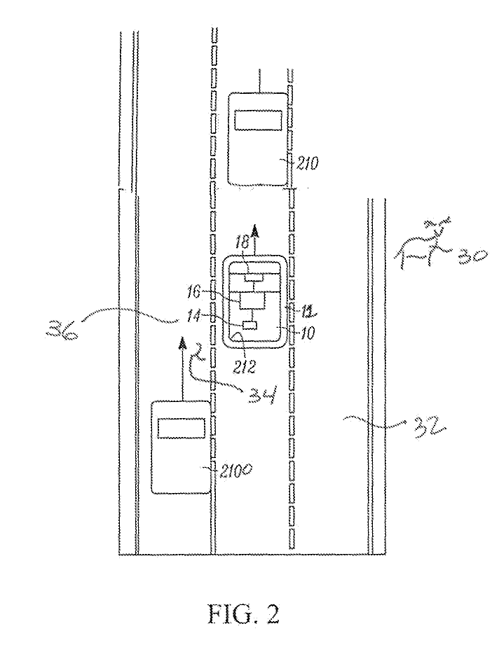

In one example, the controller 16 and the driver assistance device or system 18 are configured to assist a driver with operation of the vehicle 10 by automatically braking the vehicle 10 and/or providing blind spot assistance. For example, referring to FIG. 2, a driver in the vehicle 10 may be distracted by looking out of the vehicle 10 at an animal 30 on the side of the road 32. The vehicle 10 may quickly approach a slower-moving or stopped second vehicle 210 without the driver having enough time to avoid an accident. Accordingly, the controller 16 and the driver assistance device or system 18 work together to identify that the second vehicle 210 is a hazard in the road 32, and that the driver is distracted. Thus, the controller 16 is configured to activate the driver assistance device or system 18 if the driver is distracted and the hazard detecting device(s) (sensors 20) detect that the second vehicle 210 provides a hazard that will not likely otherwise be avoided. Therefore, the controller 16 and the driver assistance device or system 18 are configured to to regulate the speed of the vehicle 10 by providing for automatic braking to prevent the vehicle 10 from hitting the second vehicle 210. For example, a form of adaptive cruise control may be used to regulate the distance between the vehicle 10 and the second vehicle 210 if the controller 16 determines that the driver is not paying attention, based on the data from the camera of the driver analyzer 14.

Furthermore, a third vehicle 2100 may approach the vehicle 10 and enter a blind spot 34 of the vehicle 10. Since the driver of the vehicle 10 is distracted by the animal 30 (or anything else, such as changing the radio, dropping something, talking to rear seat passengers, etc.), the driver may cause the vehicle 10 to move at least partially into the left lane 36 containing the third vehicle 2100 without realizing that the third vehicle 2100 is in his/her blind spot 34. The driver assistance system 18 can be configured to produce an alert, such as an audio alert or a visual to the driver. The driver assistance system 18 may be further configured to vibrate the steering wheel 19 and/or to correct the steering or resist steering in the direction of the third vehicle 2100, in order to assist the driver with avoiding an accident with the third vehicle 2100. Thus, in some examples, the driver assistance device or system 18 may employ a steering assist system and/or a lane departure warning or assist system.

In yet further alternate examples, the driver assist device or system 18 include an infotainment system. The infotainment system includes a wireless connection to a data network. Through the connection to the data network, the infotainment system can gather news tickers, sports scores, or any other appropriate information. In some variations, the information gathered by the infotainment system may be provided to the controller 16 and affect the alerting device of the driver assistance device or system 18.

In another example, the interior 13 may include one or more audio speakers 40 or other audio output devices. The alert may be an audio alert which is played as a warning sound or message for the driver over speakers or other audio output devices.

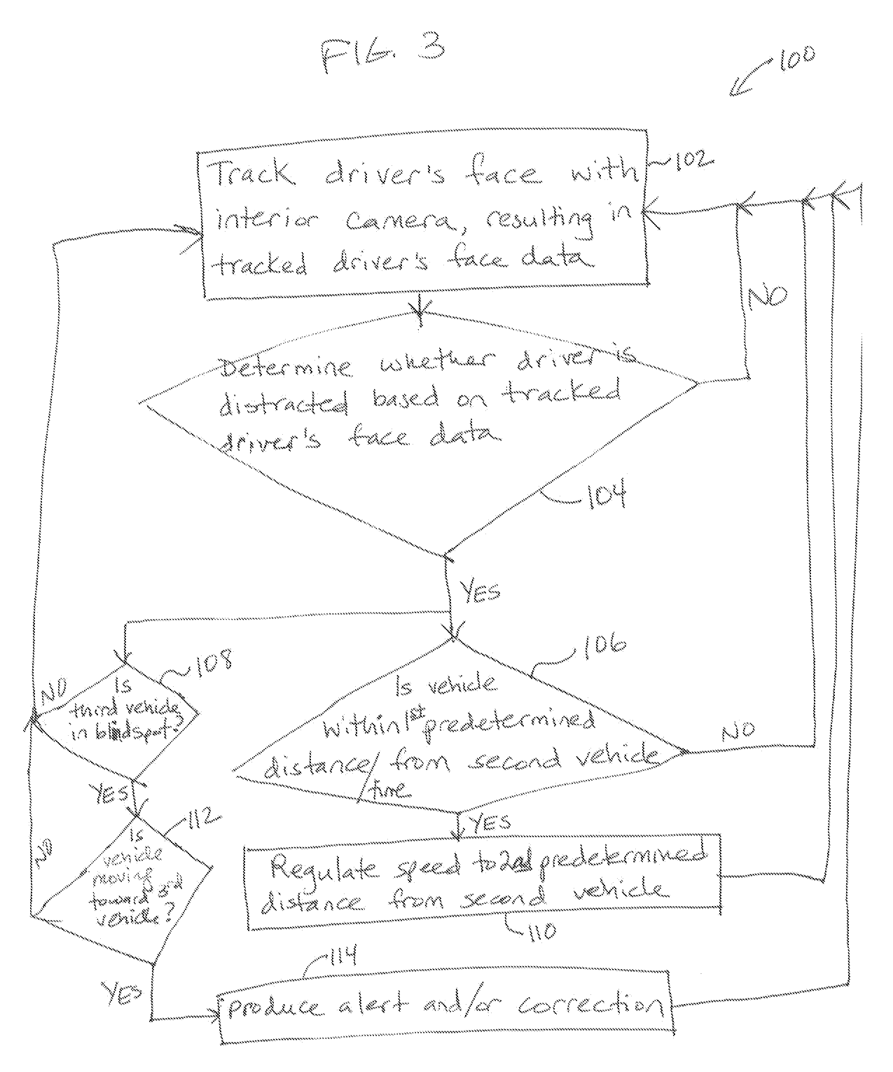

FIG. 3 illustrates a method 100 for assisting a driver of a vehicle. The method 100 may be incorporated into a non-transitory machine-readable medium that provides instructions, which when executed by a machine, cause the machine to perform operations, in some examples.

The method 100 includes a step 102 of tracking a driver's face with an interior camera, resulting in tracked driver's face data. The method 100 then includes a step 104 of determining whether the driver is distracted based on the tracked driver's face data. If the driver is not distracted, the method returns to step 102. If, however, it is determined in step 104 that the driver is distracted, the method 100 proceeds to a step 106 and a step 108.

In the step 106, the method 100 includes determining whether the vehicle is within a first predetermined distance from a second vehicle. If not, then the method 100 returns to step 102. If, however, it is determined that the vehicle is within a first predetermined distance from the second vehicle, the method 100 proceeds to a step 110 of regulating the speed of the vehicle to a second predetermined distance from the second vehicle, for example, using a form of adaptive cruise control. After the step 110 of speed regulation, the method 100 returns to step 102.

In the step 108, the method includes determining whether a third vehicle is in the driver's blind spot, such as shown in FIG. 2. If not, the method 100 returns to step 102. If, however, it is determined that a third vehicle is in the driver's blind spot, the method proceeds to a step 112 of determining whether the vehicle is moving toward the third vehicle. If not, the method 100 returns to the step 102. If, however, it is determined that the vehicle is moving toward the third vehicle, the method 100 proceeds to a step 114 of producing an alert (e.g., audio tone or steering wheel vibration) and/or a correction such as steering resistance or assistance, as explained above.

A non-transitory machine-readable medium may be provided that provides instructions, which when executed by a machine, cause the machine to perform operations, such as the method 100. For example, the operations may include tracking the face of a driver of a first vehicle with an interior camera, resulting in tracked driver's face data; determining whether the driver is distracted based on the tracked driver's face data; if the driver is distracted and the first vehicle is within a first predetermined distance from a second vehicle, regulating speed to a predetermined distance from the second vehicle; and if the driver is distracted and a third vehicle is in a blind spot of the driver, and further if the first vehicle moves toward the third vehicle, producing at least one of an alert and a correction.

Further, the operations may include vibrating a steering wheel of the first vehicle, producing a resistance of the steering wheel, producing an audio alert, applying an adaptive cruise control system, applying a steering assist system, applying a lane departure warning system, and/or interpreting data from a driver analyzer using a controller.

It is further understood that any of the above described concepts can be used alone or in combination with any or all of the other above described concepts. Although an embodiment of this invention has been disclosed, a worker of ordinary skill in this art would recognize that certain modifications would come within the scope of this invention. For that reason, the following claims should be studied to determine the true scope and content of this invention.

What is claimed is:

1. A safe driving system for alerting a driver within a first automotive vehicle, the safe driving system comprising:
a driver assistance device configured to assist a driver with operation of the first vehicle by performing at least one of the following: automatically braking the first vehicle if the first vehicle is within a predetermined distance of a second vehicle and providing blind spot assistance if a third vehicle is in a blind spot of the driver;
a controller configured to track a driver's face with an interior camera resulting in tracked driver's face data, the controller being further configured to determine whether the driver is distracted based on the tracked driver's face data;
a hazard detecting device communicatively coupled to the controller, the hazard detecting device being configured to detect the second vehicle and the third vehicle,
wherein the controller is configured to activate the driver assistance device if the driver is distracted and the hazard detecting device detects at least one of the second vehicle and the third vehicle.

2. The safe driving system of claim 1, the predetermined distance being a first predetermined distance, wherein the driver assistance device is configured to regulate speed to a second predetermined distance from the second vehicle if the driver is distracted.

3. The safe driving system of claim 2, wherein the driver assistance device is configured to producing at least one of an alert or a correction if the driver is distracted and the third vehicle is in a blind spot of the driver, and further if the first vehicle moves toward the third vehicle.

4. The safe driving system of claim 3, driver assistance device is configured to vibrate a steering wheel of the first vehicle, the driver assistance device being further configured to produce a resistance of the steering wheel of the first vehicle, the driver assistance device being further configured to produce an audio alert.

5. The safe driving system of claim 4, wherein the driver assistance device is configured to apply an adaptive cruise control system.

6. The safe driving system of claim 5, wherein driver assistance device is configured to apply at least one of a steering assist system and a lane departure warning system.

7. The safe driving system of claim 6, wherein the apparatus is configured to identify at least one of the second vehicle and the third vehicle with long range radar.

8. A method for assisting a driver of a first vehicle, the method comprising the steps of:
tracking a driver's face with an interior camera, resulting in tracked driver's face data;
determining whether the driver is distracted based on the tracked driver's face data;
if the driver is distracted and the first vehicle is within a first predetermined distance from a second vehicle, regulating speed to a second predetermined distance from the second vehicle; and
if the driver is distracted and a third vehicle is in a blind spot of the driver, and further if the first vehicle moves toward the third vehicle, producing at least one of an alert and a correction.

9. The method of claim 8, wherein the step of producing at least one of an alert or a correction includes vibrating a steering wheel of the first vehicle.

10. The method of claim 9, wherein the step of producing at least one of an alert or a correction includes producing a resistance of the steering wheel of the first vehicle.

11. The method of claim 10, wherein the step of producing at least one of an alert or a correction includes producing an audio alert.

12. The method of claim 11, wherein the step of regulating speed to a second predetermined distance from the second vehicle if the driver is distracted and the first vehicle is within a first predetermined distance from a second vehicle includes applying an adaptive cruise control system.

13. The method of claim 12, wherein the step of producing at least one of an alert or a correction if the driver is distracted and a third vehicle is in a blind spot of the driver, and further if the first vehicle moves toward the third vehicle, includes applying at least one of a steering assist system and a lane departure warning system.

14. The method of claim 13, wherein the step of determining whether the driver is distracted based on the tracked driver's face data includes interpreting data from a driver analyzer using a controller.

15. The method of claim 14, wherein method further includes identifying at least one of the second vehicle and the third vehicle with long range radar.

16. A non-transitory machine-readable medium that provides instructions, which when executed by a machine, cause the machine to perform operations comprising:
tracking the face of a driver of a first vehicle with an interior camera resulting in tracked driver's face data;
determining whether the driver is distracted based on the tracked driver's face data;
if the driver is distracted and the first vehicle is within a first predetermined distance from a second vehicle, regulating speed to a second predetermined distance from the second vehicle; and
if the driver is distracted and a third vehicle is in a blind spot of the driver, and further if the first vehicle moves toward the third vehicle, producing at least one of an alert and a correction.

17. The non-transitory machine-readable medium of claim 16, wherein the non-transitory machine-readable medium provides instructions which when executed by a machine, cause the machine to perform operations comprising producing at least one of an alert or a correction includes vibrating a steering wheel of the first vehicle.

18. The non-transitory machine-readable medium of claim 17, wherein the step of producing at least one of an alert or a correction includes producing a resistance of the steering wheel of the first vehicle and producing an audio alert.

19. The non-transitory machine-readable medium of claim 18, wherein the step of regulating speed to a second predetermined distance from the second vehicle if the driver is distracted and the first vehicle is within a first predetermined distance from a second vehicle includes applying an adaptive cruise control system.

20. The non-transitory machine-readable medium of claim 19, wherein the step of producing at least one of an alert or a correction if the driver is distracted and a third vehicle is in a blind spot of the driver, and further if the first vehicle moves toward the third vehicle, includes applying at least one of a steering assist system and a lane departure warning system.
